(19) United States
(12) Patent Application Publication
(10) Pub. No.: US 2016/0188354 A1
(43) Pub. Date: Jun. 30, 2016

(54) EFFICIENT ENABLING OF EXTENDED PAGE TABLES

(71) Applicants: Michael Goldsmith, Lake Oswego, OR (US); Ravi Sahita, Beaverton, OR (US)

(72) Inventors: Michael Goldsmith, Lake Oswego, OR (US); Ravi Sahita, Beaverton, OR (US)

(21) Appl. No.: 14/582,858

(22) Filed: Dec. 24, 2014

(51) Int. Cl. G06F 9/455

(52) U.S. Cl. CPC G06F 9/45558; G06F 2009/45583

(57) ABSTRACT

Embodiments of an invention for efficient enabling of EPTs are disclosed. In one embodiment, a processor includes instruction hardware, control logic, and execution hardware. The instruction hardware is to receive a plurality of instructions, including an instruction to switch an extended page table pointer (EPTP) in a non-root mode. The control logic is logic to determine, in response to receiving the instruction, whether to cause a first virtual machine exit, wherein the determination is based on whether a valid entry is found in an active EPTP list. The execution hardware is to execute a virtual machine monitor, wherein the virtual machine monitor is to activate a populated EPTP list in response to determining that extended page tables are being used and to activate an unpopulated EPTP list in response to determining that extended page tables are not being used.

### BACKGROUND

1. Field

The present disclosure pertains to the field of information processing, and more particularly, to the field of virtualizing resources in information processing systems.

2. Description of Related Art

Generally, the concept of virtualization of resources in information processing systems allows multiple instances of one or more operating systems (each, an “OS”) to run on a single information processing system, even though each OS is designed to have complete, direct control over the system and its resources. Virtualization is typically implemented by using software (e.g., a virtual machine monitor, or a “VMM”) to present to each OS a “virtual machine” (“VM”) having virtual resources, including one or more virtual processors, that the OS may completely and directly control, while the VMM maintains a system environment for implementing virtualization policies such as sharing and/or allocating the physical resources among the VMs (the “virtual environment”).

A processor in an information processing system may support virtualization, for example, by operating in two modes—a “root” mode in which software runs directly on the hardware, outside of any virtualization environment, and a “non-root” mode in which software runs at its intended privilege level, but within a virtual environment hosted by a VMM running in root mode. In the virtual environment, certain events, operations, and situations, such as external interrupts or attempts to access privileged registers or resources, may be intercepted, i.e., cause the processor to exit the virtual environment so that the VMM may operate, for example, to implement virtualization policies (a “VM exit”). The processor may support instructions for establishing, entering, exiting, and maintaining a virtual environment, and may include register bits or other structures that indicate or control virtualization capabilities of the processor.

### BRIEF DESCRIPTION OF THE FIGURES

The present invention is illustrated by way of example and not limitation in the accompanying figures.

FIG. 1 illustrates a virtualization architecture in which an embodiment of the present invention may provide for efficient enabling of extended page tables.

FIG. 2 illustrates a processor and a system memory including support for efficient enabling of page tables according to an embodiment of the present invention.

FIG. 3 illustrates a method for efficient enabling of extended page tables according to an embodiment of the present invention.

### DETAILED DESCRIPTION

Embodiments of an invention for efficient enabling of extended page tables are described below. In this description, numerous specific details, such as component and system configurations, may be set forth in order to provide a more thorough understanding of the present invention. It will be appreciated, however, by one skilled in the art, that the invention may be practiced without such specific details. Additionally, some well-known structures, circuits, and other features have not been shown in detail, to avoid unnecessarily obscuring the present invention.

In the following description, references to “one embodiment,” “an embodiment,” “example embodiment,” “various embodiments.” etc., indicate that the embodiment(s) of the invention so described may include particular features, structures, or characteristics, but more than one embodiment may and not every embodiment necessarily does include the particular features, structures, or characteristics. Further, some embodiments may have some, all, or none of the features described for other embodiments.

As used in this description and the claims and unless otherwise specified, the use of the ordinal adjectives “first,” “second,” “third,” etc. to describe an element merely indicate that a particular instance of an element or different instances of like elements are being referred to, and is not intended to imply that the elements so described must be in a particular sequence, either temporally, spatially, in ranking, or in any other manner.

Also, the terms “bit,” “flag,” “field,” “entry.” “indicator,” etc., may be used to describe any type of storage location in a register, table, database, or other data structure, whether implemented in hardware or software, but are not meant to limit embodiments of the invention to any particular type of storage location or number of bits or other elements within any particular storage location. The term “clear” may be used to indicate storing or otherwise causing the logical value of zero to be stored in a storage location, and the term “set” may be used to indicate storing or otherwise causing the logical value of one, all ones, or some other specified value to be stored in a storage location; however, these terms are not meant to limit embodiments of the present invention to any particular logical convention, as any logical convention may be used within embodiments of the present invention.

Also, as used in descriptions of embodiments of the present invention, a “/” character between terms may mean that an embodiment may include or be implemented using, with, and/or according to the first term and/or the second term (and/or any other additional terms).

As described in the background section, a processor may support virtualization of resources in an information processing system. One such resource is system memory, in which multiple protected domains may be created, each for use by one or more virtual machines. Techniques to virtualize system memory and a processor's memory address translation hardware may involve the use of extended page tables (EPTs) as further described below. Since the use of EPTs may decrease performance and increase power consumption, efficient enabling of EPTs according an embodiment of the present invention may be desired.

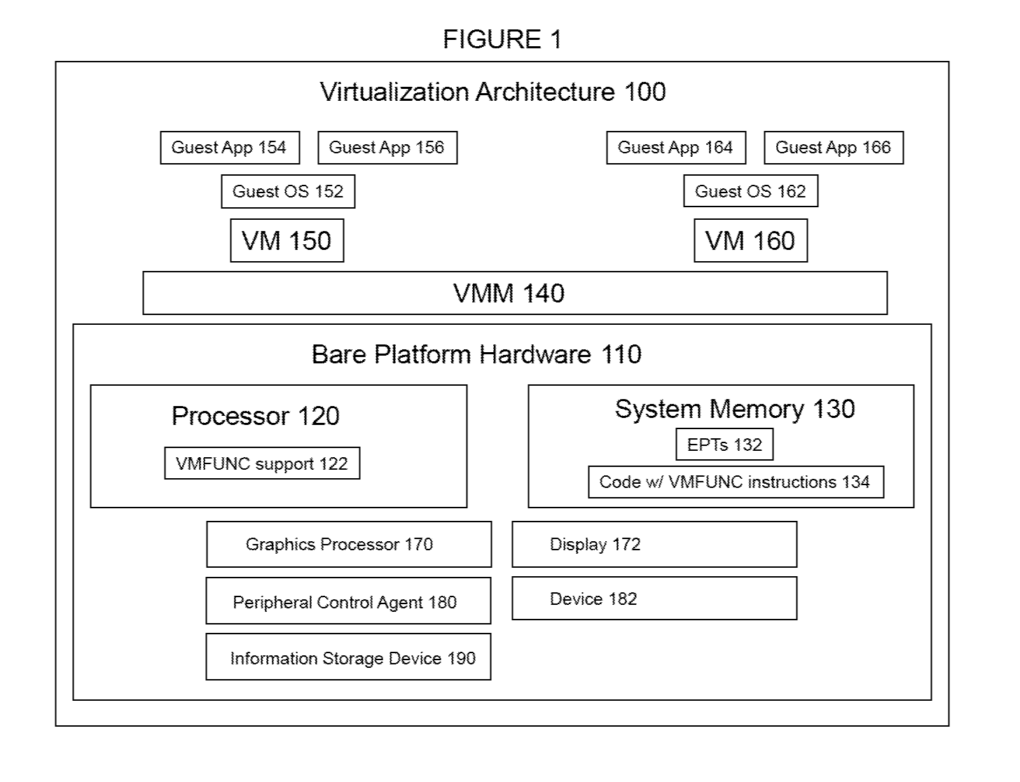

FIG. 1 illustrates virtualization architecture 100, in which an embodiment of the present invention may provide for efficient enabling of EPTs. In FIG. 1, bare platform hardware 110 may be any data processing apparatus capable of executing any OS, VMM, or other software. For example, bare platform hardware 110 may be that of a personal computer, mainframe computer, portable computer, handheld device, smartphone, tablet, set-top box, server, or any other computing system.

Bare platform hardware 110 includes processor 120, system memory 130, graphics processor 170, peripheral control agent 180, and information storage device 190. Systems embodying the present invention may include any number of each of these components and any other components or other elements, such as peripherals and input/output devices. Any or all of the components or other elements in this or any system embodiment, may be connected, coupled, or otherwise in communication with each other through any number of buses, point-to-point, or other wired or wireless interfaces or connections. Any components or other portions of bare platform hardware 110, whether shown in FIG. 1 or not shown in FIG. 1, may be integrated or otherwise included on or in a single chip (a system-on-a-chip or SOC), die, substrate, or package.

System memory 130 may be dynamic random access memory or any other type of medium readable by processor 120. System memory 130 may be used to store EPTs 132 and/or program code 134, including one or more VMFUNC instructions, according to an embodiment of the present invention, as further described below.

Graphics processor 170 may include any processor or other component for processing graphics data for display 172. Peripheral control agent 180 may represent any component, such as a chipset component, including or through which peripheral, input/output (I/O), or other components or devices, such as device 182 (e.g., a touchscreen, keyboard, microphone, speaker, other audio device, camera, video or other media device, network adapter, motion or other sensor, receiver for global positioning or other information, etc.) and/or information storage device 190, may be connected or coupled to processor 120. Information storage device 190 may include any type of persistent or non-volatile memory or storage, such as a flash memory and/or a solid state, magnetic, or optical disk drive.

Processor 120 may represent one or more processors or processor cores integrated on a single substrate or packaged within a single package, each of which may include multiple threads and/or multiple execution cores, in any combination. Each processor represented as or in processor 120 may be any type of processor, including a general purpose microprocessor, such as a processor in the Intel® Core® Processor Family, the Atom® Processor Family, or other processor family from Intel® Corporation or another company, a special purpose processor or microcontroller, or any other device or component in an information processing system in which an embodiment of the present invention may be implemented.

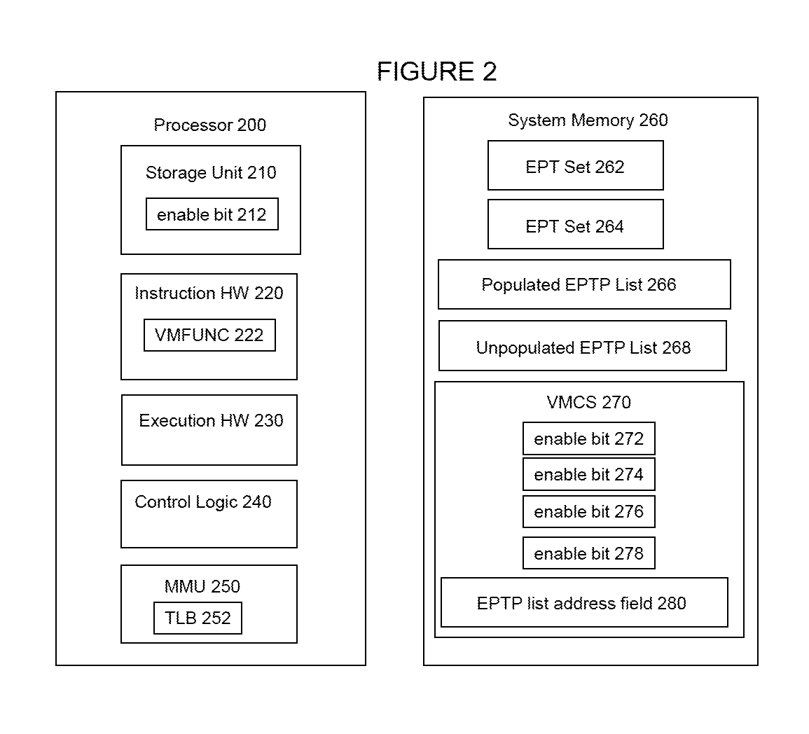

FIG. 2 illustrates processor 200 and system memory 260, which may represent an embodiment of processor 120 and an embodiment of system memory 130 in FIG. 1. Processor 200 includes storage unit 210, instruction hardware 220, execution hardware 230, control logic 240, and memory management unit (MMU) 250, each as described below. System memory 260 may include VMCS 270, as described below. Processor 200 may also include any other hardware and/or logic not shown.

Storage unit 210 may include any combination of any type of storage usable for any purpose within processor 200; for example, it may include any number of readable, writable, and/or read-writable registers, buffers, and/or caches, implemented using any memory or storage technology, in which to store capability information, configuration information, control information, status information, performance information, instructions, data, and any other information usable in the operation of processor 200, as well as circuitry usable to access such storage

Instruction hardware 220 may include any circuitry, logic, structures, and/or other hardware, such as an instruction decode, to fetch, receive, decode, interpret, schedule, and/or otherwise handle instructions to be executed by processor 200. Processor 200 may operate according to an instruction set architecture that includes any number of instructions to support virtualization. Embodiments of the present invention may be practiced with a processor having an instruction set architecture of a processor family from Intel® Corporation, using instructions that may be part of a set of virtualization extensions to any existing instruction set architecture, or according to another approach. Support for these instructions may be implemented in processor 200 using any combination of circuitry and/or logic embedded in hardware, microcode, firmware, and/or other structures. Each instruction may include an opcode and one or more operands, where the opcode may be decoded into one or more micro-instructions or micro-operations for execution by execution hardware 230. Operands or other parameters may be associated with an instruction implicitly, directly, indirectly, or according to any other approach.

As further described below, processor 200 may support an instruction (VMFUNC) allows functions provided to support virtualization to be called from within a VM, without causing a VM exit. Support for this instruction is represented as VMFUNC block 222 (also shown in FIG. 1 as VMFUNC support 122).

Execution hardware 230 may include any circuitry, logic, structures, and/or other hardware, such as arithmetic units, logic units, floating point units, shifters, etc., to process data and execute instructions, micro-instructions, and/or micro-operations. Execution hardware 230 may represent any one or more physically or logically distinct execution units.

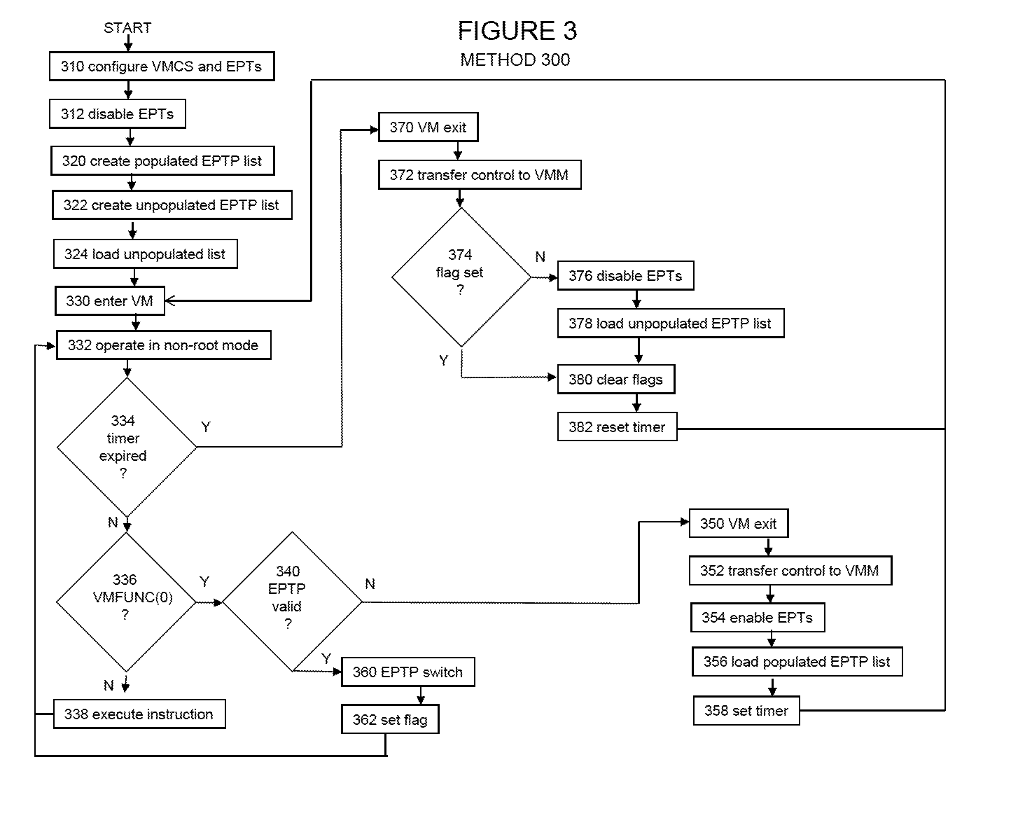

Control logic 240 may include any microcode, firmware, circuitry, structures, programmable logic, hard-coded logic, and/or other logic and hardware to control the operation of execution hardware 230 and other units of processor 200. Control logic 240 may cause processor 200 to perform or participate in the performance method embodiments of the present invention, such as the method embodiment illustrated in FIG. 3, for example, by causing execution hardware 230 to include the execution of one or more micro-instructions or micro-operations to support virtualization in its response to virtualization or other instructions received from instruction unit 220 or events occurring on bare platform hardware 110.

MMU 250 may include any circuitry, logic, structures, and/or other hardware to manage the memory space of processor 200. MMU 250 supports the use of virtual memory to provide software, including software running in a VM, with an address space for storing and accessing code and data that is larger than the address space of the physical memory in the system, e.g., system memory 130. The virtual memory space of processor 200 may be limited only by the number of address bits available to software running on the processor, while the physical memory space of processor 200 is further limited to the size of system memory 130. MMU 250 supports a memory management scheme, such as paging, to swap the executing software's code and data in and out of system memory 130 on an as-needed basis. As part of this scheme, the software may access the virtual memory space of the processor with an un-translated address that is translated by the processor to a translated address that the processor may use to access the physical memory space of the processor.

Accordingly, MMU 250 may include translation lookaside buffer 252 to store translations of a virtual, logical, linear, or other un-translated address to a physical or other translated address, according to any known memory management technique, such as paging. To perform these address translations, MMU 250 may refer to one or more data structures stored in processor 200, system memory 130, any other storage location in system 100 not shown in FIG. 1, and/or any combination of these locations. The data structures may include page directories and page tables according to the architecture of the Pentium® Processor Family.

Returning to FIG. 1, in addition to bare platform hardware 110, virtualization architecture 100 includes VMM 140, VMs 150 and 160, OSs 152 and 162, and applications 154, 156, 164, and 166. A VM may be referred to as a “guest machine” or “guest” (e.g., VMs 150 and 160), an OS that runs on a VM may be referred to as a “guest OS” (e.g., OSs 152 and 162), and an application that runs on a VM may be referred to as a “guest application” (e.g., applications 154, 156, 164, and 166). VMM 140 may represent any VMM, hypervisor, or other software or firmware installed on or accessible to bare platform hardware 110 to present VMs, i.e., abstractions of bare platform hardware 110, to guest OSs and guest applications, or to otherwise create VMs, manage VMs, and implement virtualization policies. A platform, system, or machine (including a guest machine in the case of nested virtualization) may be referred to as a “host machine” or “host” (e.g., bare platform hardware 110).

Each guest OS and guest application expects to access resources, such as processor and platform registers, memory, and input/output devices, according to the architecture of the virtual processor and the platform presented in the VM, where the expected resources may correspond to any combination of actual physical resources of bare platform hardware 110, virtual resources provided or supported by actual physical resources of bare platform hardware 110 (e.g., by sharing), and/or virtual resources provided by software emulation of physical resources. Therefore, any single embodiment of the present invention may include any number of guest OSs and guest applications written for any number of different hardware platforms. Although FIG. 1 shows two VMs, 150 and 160, with guest OS 152 and guest applications 154 and 156 installed on VM 150 and guest OS 162 and guest applications 164 and 166 installed on VM 160, any number of VMs may be created and any number of guest applications may run on each VM within the scope of the present invention.

A resource that can be accessed by a guest OS (and sometimes by a guest application) may either be classified as a “privileged” or a “non-privileged” resource. For a privileged resource, VMM 140 facilitates the functionality desired by the guest OS or guest application while retaining ultimate control over the resource. Non-privileged resources do not need to be controlled by VMM 140 and may be accessed directly by a guest OS (and sometimes by a guest application).

Furthermore, each guest OS expects to handle various events such as exceptions (e.g., page faults, and general protection faults), interrupts (e.g., hardware interrupts and software interrupts), and platform events (e.g., initialization and system management interrupts). These exceptions, interrupts, and platform events are referred to collectively and individually as “events” herein. Some of these events are “privileged” because special handling of these events may be desired to ensure proper operation of VMs 150 and 160, protection of VMM 140 from guest OSs and guest applications, and protection of guest OSs and guest applications from each other.

At any given time, processor 120 may be executing instructions from VMM 140 or any guest OS or guest application, thus VMM 140 or the guest OS or guest application may be running on, or in control of, processor 120. When a privileged event occurs or a guest OS or guest application attempts to access a privileged resource, a VM exit may occur, transferring control from the guest OS or guest application to VMM 140. After handling the event or emulating or facilitating the access to the resource appropriately, VMM 140 may return control to a guest OS or guest application. The transfer of control from VMM 140 to a guest OS or guest application (including an initial transfer to a guest OS or guest application on a newly created VM) is referred to as a “VM entry” herein. Instructions that are executed to transfer control to a VM may be referred to generically as “VM enter” instructions, and for example, may include a VMLAUCH and a VMRESUME instruction in the instruction set architecture of a processor in the Core® Processor Family.

Processor 120 may control the operation of VMs 150 and 160 according to data stored in one or more virtual machine control structures (each, a “VMCS”). A VMCS is a data structure that may contain state of one or more guests, state of a host, execution control information indicating how VMM 140 is to control operation of a guest or guests, execution control information indicating how VM exits and VM entries are to operate, information regarding VM exits and VM entries, any other such information. Processor 120 reads information from the VMCS to determine the execution environment of a VM and constrain its behavior. Embodiments may use one VMCS per VM, or any other arrangement may be used in other embodiments. Each VMCS may be stored, in whole or in part, in memory 130, and/or elsewhere, such as being copied to a cache memory of a processor.

Each VMCS may include any number of indicators or other controls to protect any number of different resources. For example, any size area of memory may be protected at any granularity (e.g., a 4 KB page) using a set of extended page tables (“EPT”), which provide for each VM, if desired, to have its own virtual memory space and, from the perspective of a guest OS, its own physical memory space. The addresses that a guest application uses to access its linear or virtual memory may be translated, using page tables configured by a guest OS, to addresses in the memory space that appears (through the virtualization supported by the processor and the VMM) as system memory to the guest OS (each, a “guest physical address” or “GPA”). The GPAs may be translated to addresses (each, a “host physical address” or “HPA”) in actual system memory (e.g., memory 130), through the EPTs (which have been configured by the VMM prior to a VM entry) without causing a VM exit. EPT entries may include permissions (e.g., read, write, and/or execute permissions) and/or other indicators to enforce access restrictions.

Therefore, EPTs may be used to create protected domains in system memory. Each such domain may correspond to a different set of EPT paging structures, each defining a different view of memory with different access permissions (each, a permission view), and each referenced by a different EPT pointer (EPTP). A switch from one permission view to another permission view (for example, as a result of loading a different EPTP value into a designated VM-execution control field in a VMCS) may be called a view switch.

From within a VM, an attempt to perform an unpermitted access to a page or other data structure in a protected domain is called an EPT violation and may cause a VM exit, which may provide for a VMM, hypervisor, or other root-mode software (each of which may be referred to as a VMM for convenience) to determine whether the access should be permitted. If so, the VMM may perform a view switch and cause a re-entry into the VM. To avoid the overhead of the VM exit involved in this scenario, an instruction (VMFUNC) may be used to allow a view switch to be performed from non-root mode (i.e., from within a VM), without causing a VM exit. A first parameter associated with the VMFUNC instruction (e.g., the value in the EAX register in a processor in the Intel® Core® Processor Family) may specify that the function to be invoked is an EPT pointer (EPTP) switching function (for example, the value of ‘0’ in the EAX register may specify the EPTP switching function, which may therefore be referred to as “VMFUNC(0)”). To provide for a VMM to enforce domain protections, software running in non-root mode may be limited to selecting from a list of EPTP values configured in advance by root-mode software. Then, a second parameter associated with the VMFUNC instruction (e.g., the value in the ECX register in a processor in the Intel® Core® Processor Family) may be used as an index to select an entry from the EPTP list. If the specified entry is invalid or does not exist, the VMFUNC(0) instruction results in a VM exit.

The virtualization functionality and support described above may be subject to any number and/or level of enablement controls. In an embodiment, a global virtualization control, e.g. a designated bit in a control register in the processor (bit 212 in storage unit 210), may be used to enable or disable the use of non-root mode. A secondary controls activation control, e.g., a designated bit in a designated VM-execution control field of a VMCS (bit 272 in VMCS 270), may be used to enable a secondary level of controls for execution in non-root mode. The secondary controls may include an EPT enable control, e.g., a designated bit in a designated VM-execution control field of the VMCS (bit 274 in VMCS 270), that may be used to enable the use of EPTs. The secondary controls may also include a VM function enable control, e.g., a designated bit in a designated VM-execution control field of the VMCS (bit 276 in VMCS 270), that may be used to enable the use of the VMFUNC instruction. A VMFUNC(0) control bit, e.g., a designated bit in a designated VM-function control field of a VMCS (bit 278 in VMCS 270), may be used to enable the use of the EPTP switching function. Note that in this embodiment, the use of EPTs and the EPTP switching function is not enabled unless all of bits 212, 272, 274, 276, and 278 are set.

A VMM may create multiple sets of EPTs (e.g., EPT sets 262 and 264) for use within a single VM, and may create a populated EPTP list (e.g., EPTP list 266) including multiple pointers, where each pointer is to one of the multiple sets of EPTs). Additionally, a VMM may create an unpopulated or empty EPTP list (e.g., EPTP list 268) to provide for efficient enabling of EPTs according to an embodiment of the present invention. The VMFUNC(0) instruction may reference a designated VM-function field of a VMCS (e.g., field 280 of VMCS 270) for the address of the EPTP list.

Therefore, the VMM may load the address of either populated EPTP list 266 or unpopulated EPTP list 268 into EPTP list address field 280 in order to control whether the VMFUNC(0) instruction results in a VM exit. More specifically, when EPTP list address field 280 contains the address of populated EPTP list 266, the VMFUNC(0) instruction may be used by non-root mode software without causing a VM exit, but when field 280 contains the address of unpopulated EPTP list 268, the use of the VMFUNC(0) instruction by non-root mode software causes a VM exit.

The VMM may switch the contents of EPTP list address field 280 between populated EPTP list 266 and unpopulated EPTP list 268 to provide for efficient enabling of EPTs. For example, a method 300 for efficient enabling of EPTs according to an embodiment of the present invention is illustrated in FIG. 3. Although method embodiments of the invention are not limited in this respect, reference may be made to elements of FIGS. 1 and 2 to help describe the method embodiment of FIG. 3. Various portions of method 300 may be performed by hardware, firmware, software, and/or a user of a system. Hardware, firmware, software, and/or a user of a system may also perform other actions (not shown) in connection with the actions shown.

In box 310 of method 300, a VMM (e.g., VMM 140) operating in root mode on a processor (e.g., processor 120), configures one or more VMCSs (e.g., VMCS 270) and one or more sets of EPTs (e.g., EPT sets 262 and 264) to establish protection domains. Note that in embodiments including layered virtualization architecture, the VMM may be operating in non-root mode.

In box 312, the VMM configures a VM to operate without EPTs (e.g., by clearing bit 274 or leaving it in a default cleared state). Therefore, the VM may be used by non-root mode software without the performance and power penalty of EPTs.

In box 320, the VMM creates a populated EPTP list (e.g., EPTP list 266). In box 322, the VMM creates an unpopulated EPTP list (e.g., EPTP list 268). In box 324, the VMM configures the VM to use the unpopulated EPTP list (e.g., by loading unpopulated EPTP list 268 into EPTP list address field 280).

In box 330, control of the processor is transferred from the VMM operating in root mode to guest software operating in the VM. In box 332, guest software operates in non-root mode. Box 332 may be entered with EPTs disabled (e.g., see above) or with EPTs enabled (e.g., see below).

With EPTs disabled, guest software operates in non-root mode in the VM, avoiding the EPT performance and power penalty. As long there is no need for the use of EPTs, no attempt will be made to execute a VMFUNC(0) instruction, and the EPT performance and power penalty may be avoided automatically (i.e., without further action of the VMM). With EPTs enabled, the EPT virtualization feature may be used to enforce protection of domains.

In box 334, an EPT activity timer (as described below) may expire. If so, then method 300 continues in box 370. If not, then method 300 continues in box 336.

In box 336, a guest software instruction is attempted in non-root mode. If the instruction is not a VMFUNC(0) instruction (or other instruction that results causes a VM exit or other change to method 300), then in box 338, the instruction is executed and method 300 continues in box 332. If the instruction is a VMFUNC(0) instruction, then method 300 continues in box 340.

In box 340, an attempt is made to find the EPTP list entry referenced by the VMFUNC(0). If the EPTP list entry is invalid or does not exist, as would be the case when EPTP list address field 280 contains the address of unpopulated EPTP list 268 (e.g., box 330 has been entered from box 324), method 300 continues in box 350. However, if the EPTP list entry is found and is valid, as would be the case when EPTP list address field 280 contains the address of populated EPTP list 266 (e.g., box 330 has been entered from box 362), method 300 continues in box 360.

In box 350, the VMFUNC(0) instruction results in a VM exit because the EPTP list entry in invalid or does not exist (e.g., the active EPTP list is unpopulated). In box 352, in connection with the VM exit, control of the processor is transferred to the VMM. In box 354, the VMM configures the VM to operate with EPTs (e.g., by setting bit 274). In box 356, the VMM configures the VM to use the populated EPTP list (e.g., by loading populated EPTP list 266 into EPTP list address field 280). In box 358, the VMM sets an EPT activity timer (e.g., based on real-time clock 184) to cause a VM exit at the expiration of a period of time of any desired length. From box 358, method 300 continues in box 330.

In box 360, execution of the VMFUNC(0) instruction succeeds, i.e., results in an EPTP switch because a valid EPTP list entry has been found (e.g., the active EPTP list is populated). Note that box 360 may result from a subsequent attempt to execute the same VMFUNC(0) instruction (i.e., with the same parameters) that was previously attempted when the active EPTP list was unpopulated; so execution of the guest software does proceed as expected despite the interception by the VMM to enable EPTs and load the address of the populated EPTP list.

In box 362, an EPT activity flag is set in connection with the successful execution of the VMFUNC(0) instruction. The EPT activity flag may be stored in any designated storage location that is known to and accessible by the VMM, to indicate that EPTs are being used. The flag may be set according to any of various approaches. In an embodiment, code that is executed immediately before, after, or otherwise in connection with the view switch may set the flag. The code may be included in the guest software. Alternatively, the setting may be performed (subject to being previously enabled or configured by the VMM) by control logic 240. From box 362, method 300 continues in box 332.

In box 370, a VM exit occurs in connection with the expiration of the timer. In box 372, in connection with the VM exit, control of the processor is transferred to the VMM. In box 374, the VMM examines all EPT activity flags associated with the active permission views. If any EPT activity flags are set, then method 300 continues in box 380. However, if all EPT activity flags are clear, then method 300 continues in box 376.

In box 376, the VMM configures the VM to operate without EPTs (e.g., by clearing bit 274). In box 378, the VMM configures the VM to use the unpopulated EPTP list (e.g., by loading unpopulated EPTP list 268 into EPTP list address field 280).

In box 380, the VMM clears all EPT activity flags. In box 382, the VMM resets the EPT activity timer to cause a VM exit at the expiration of the time period. From box 382, method 300 continues in box 330.

Note that the checking of the EPT activity flags in box 374 provides an indication of whether EPTs were used during the previous time period. Therefore, if EPTs were used during the previous time period, the VM will be re-entered with EPTs enabled and a populated active EPTP list because boxes 376 and 378 were not performed. However, if EPTs were not used during the previous time period, the VM will be re-entered with EPTs disabled and an unpopulated active EPTP list because boxes 376 and 378 were performed.

Thus, the use of method 300 and other method embodiments of the present invention may provide for increasing performance and decreasing power in a virtualization environment by enabling EPTs only when they are needed and disabling EPTs when they are not being used.

In various embodiments of the present invention, the method illustrated in FIG. 3 may be performed in a different order, with illustrated boxes combined or omitted, with additional boxes added, or with a combination of reordered, combined, omitted, or additional boxes. Furthermore, method embodiments of the present invention are not limited to method 300 or variations thereof. Many other method embodiments (as well as apparatus, system, and other embodiments) not described herein are possible within the scope of the present invention.

Embodiments or portions of embodiments of the present invention, as described above, may be stored on any form of a machine-readable medium. For example, all or part of method 300 may be embodied in software or firmware instructions that are stored on a medium readable by processor 120, which when executed by processor 120, cause processor 120 to execute an embodiment of the present invention. Also, aspects of the present invention may be embodied in data stored on a machine-readable medium, where the data represents a design or other information usable to fabricate all or part of processor 120.

Thus, embodiments of an invention for efficient enabling of EPTs have been described. While certain embodiments have been described, and shown in the accompanying drawings, it is to be understood that such embodiments are merely illustrative and not restrictive of the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

What is claimed is:

1. A processor comprising:
instruction hardware to receive a plurality of instructions, including an instruction to switch an extended page table pointer (EPTP) in a non-root mode;
control logic to determine, in response to receiving the instruction, whether to cause a first virtual machine exit, wherein the determination is based on whether a valid entry is found in an active EPTP list; and
execution hardware to execute a virtual machine monitor, wherein the virtual machine monitor is to activate a populated EPTP list in response to determining that extended page tables are being used and to activate an unpopulated EPTP list in response to determining that extended page tables are not being used.

2. The processor of claim 1, wherein the activating of the unpopulated EPTP list is to result in the first virtual machine exit in response to the instruction.

3. The processor of claim 2, wherein the virtual machine monitor is to enable extended page tables in response to the first virtual machine exit.

4. The processor of claim 3, wherein the virtual machine monitor is to set a timer, wherein the expiration of the timer is to cause a second virtual machine exit.

5. The processor of claim 4, wherein the virtual machine monitor is to check an activity flag in response to the second virtual machine exit and to disable extended page tables if the activity flag is clear.

6. The processor of claim 5, wherein the control logic is also to cause an EPTP switch in response to finding the valid entry in the active EPTP list.

7. The processor of claim 6, wherein the activity flag is to be set in response to the EPTP switch.

8. The processor of claim 7, wherein the activity flag is to be cleared in response to the second virtual machine exit.

9. A method comprising:
receiving an instruction to switch an extended page table pointer (EPTP) in a non-root mode;
determining, in response to receiving the instruction, whether to cause a first virtual machine exit, wherein the determination is based on whether a valid entry is found in an active EPTP list;
determining whether extended page tables (EPTs) are being used;
activating, by a virtual machine monitor in response to determining that EPTs are being used, a populated EPTP list;
and activating, by a virtual machine monitor in response to determining that EPTs are not being used, an unpopulated EPTP list.

10. The method of claim 9, wherein the activating of the unpopulated EPTP list is to result in the first virtual machine exit in response to the instruction.

11. The method of claim 10, further comprising the virtual machine monitor enabling extended page tables in response to the first virtual machine exit.

12. The method of claim 11, further comprising the virtual machine monitor setting a timer, wherein the expiration of the timer is to cause a second virtual machine exit.

13. The method of claim 12, further comprising the virtual machine monitor checking an activity flag in response to the second virtual machine exit and disabling extended page tables if the activity flag is clear.

14. The method of claim 13, further comprising cause an EPTP switch in response to finding the valid entry in the active EPTP list.

15. The method of claim 14, further comprising setting the activity flag in response to the EPTP switch.

16. The method of claim 15, further comprising clearing the activity flag in response to the second virtual machine exit.

17. A tangible medium storing a sequence of instructions which when executed by a processor cause the processor to:
activate a populated extended page table pointer list in response to determining that EPTs are being used; and
activate an unpopulated extended page table pointer list in response to determining that EPTs are not being used.

18. The tangible medium of claim 17, wherein the activating of the unpopulated EPTP list is to result in a first virtual machine exit in response to an instruction to switch an extended page table pointer (EPTP) in a non-root mode.

19. The tangible medium of claim 18, wherein the sequence of instructions is also to cause the processor to enable extended page tables in response to the first virtual machine exit.

20. The tangible medium of claim 20, wherein the instruction to switch an EPTP in the non-root mode is to cause the processor determine is whether a valid entry is found in an active EPTP list and to switch the EPTP in response to finding the valid entry in the active EPTP list.
